(19) United States
(12) Patent Application Publication
(10) Pub. No.: US 2020/0207599 A1
(43) Pub. Date: Jul. 2, 2020

(54) APPARATUS AND METHOD FOR A MOBILE SAFETY TOWER

(71) Applicant: Security Centres International (USA) LLC, Chattanooga, TN (US)

(72) Inventors: Stuart Bostock, Lookout Moutain, GA (US); Roberta Bostock, Lookout Mountain, GA (US)

(21) Appl. No.: 16/730,536

(22) Filed: Dec. 30, 2019

Related U.S. Application Data
(60) Provisional application No. 62/785,917, filed on Dec. 28, 2018.

(51) Int. Cl. B66F 11/04; F16M 11/04; G03B 17/56; H02S 40/38

(52) U.S. Cl. CPC B66F 11/048; H02S 40/38; G03B 17/561; F16M 11/046

(57) ABSTRACT

A mobile safety tower having a base assembly that includes a base housing, an inverter, a power source, a communications router, a camera power supply unit a controller, an internally-cabled tube that is adapted to be moved between a retracted position and an extended position, a means for moving the internally-cabled tube between the retracted position and the extended position, a camera, a plurality of data collection sensors, and a solar energy source. The means for moving the internally-cabled tube between the retracted position and the extended position moves the internally-cabled tube between the retracted position and the extended position. A method for a mobile safety tower including moving the internally-cabled tube between the retracted position and the extended position.

### CROSS-REFERENCES TO RELATED APPLICATIONS/PATENTS

This application relates back to and claims the benefit of priority from U.S. Provisional application for Patent Ser. No. 62/785,917 titled “Mobile Advanced Safety Tower” and filed on Dec. 28, 2018.

### FIELD OF THE INVENTION

The present invention relates generally to apparatuses and methods for surveillance and communications assemblies and particularly to apparatuses and methods for mobile advanced surveillance and communications assemblies.

### BACKGROUND AND DESCRIPTION OF THE PRIOR ART

It is known to use apparatuses and methods to conduct surveillance and communications operations. Conventional apparatuses and methods, however, suffer from one or more disadvantages. For example, conventional apparatuses and methods are not sufficiently mobile, rapidly deployable, or autonomous. Conventional apparatuses and methods do not employ sufficiently advanced, seamless, off-the-grid technology or alternative, sustainable, renewable energy sources. Further, conventional apparatuses and methods are not sufficiently modular, robust, stable, or customizable. Still further, conventional apparatuses and methods are not sufficiently aesthetically subtle. In addition, conventional apparatuses and methods have undesirable external cabling and wiring. Conventional apparatuses and methods are also undesirably capable of being moved, tipped over, or otherwise damaged by unauthorized persons and have undesirably large footprints. Further, conventional apparatuses and methods do not provide storage space for equipment or supplies. Still further, conventional apparatuses and methods do not provide sufficient safety and security.

It would be desirable, therefore, if an apparatus and method for a mobile safety tower could be provided that would be mobile, rapidly deployable, and autonomous. It would also be desirable if an apparatus and method for a mobile safety tower could be provided that would employ advanced, seamless, off-the-grid technology and alternative, sustainable, renewable energy sources. It would be further desirable if an apparatuses and method for a mobile safety tower could be provided that would be modular, robust, stable, or customizable. It would still further be desirably if an apparatus and method for a mobile safety tower could be provided that would be aesthetically subtle. In addition, it would be desirable if an apparatus and method for a mobile safety tower could be provided that would not have external cabling and wiring. It would also be desirable if an apparatus and method for a mobile safety tower could be provided that would not be capable of being moved, tipped over, or otherwise damaged by unauthorized persons or have an undesirably large footprint. Further, it would be desirable if an apparatus and method for a mobile safety tower could be provided that provides storage space for equipment or supplies. It would be still further desirable if an apparatus and method for a mobile safety towner could be provided that provides sufficient safety and security.

### ADVANTAGES OF THE PREFERRED EMBODIMENTS OF THE INVENTION

Accordingly, it is an advantage of the preferred embodiments of the invention claimed herein to provide an apparatus and method for a mobile safety tower that is mobile, rapidly deployable, and autonomous. It is also an advantage of the preferred embodiments of the invention claimed herein to provide an apparatus and method for a mobile safety tower that employs advanced, seamless, off-the-grid technology and alternative, sustainable, renewable energy sources. It a further advantage of the preferred embodiments of the invention claimed herein to provide an apparatus and method for a mobile safety tower that is modular, robust, stable, or customizable. It is a still further advantage of the preferred embodiments of the invention claimed herein to provide an apparatus and method for a mobile safety tower that is aesthetically subtle. In addition, it is an advantage of the preferred embodiments of the invention claimed herein to provide an apparatus and method for a mobile safety tower that does not have external cabling and wiring. It is another advantage of the preferred embodiments of the invention claimed herein to provide an apparatus and method for a mobile safety tower that is not be capable of being moved, tipped over, or otherwise damaged by unauthorized persons or have an undesirably large footprint. Further, it advantage of the preferred embodiments of the invention claimed herein to provide an apparatus and method for a mobile safety tower that provides storage space for equipment or supplies. It is a still further advantage of the preferred embodiments of the invention claimed herein to provide an apparatus and method for a mobile safety tower that provides sufficient safety and security.

Additional advantages of the preferred embodiments of the invention will become apparent from an examination of the drawings and the ensuing description.

### EXPLANATION OF THE TECHNICAL TERMS

The use of the terms “a,” “an,” “the,” and similar terms in the context of describing the invention are to be construed to cover both the singular and the plural, unless otherwise indicated herein or clearly contradicted by context. The terms “comprising” “having,” “including,” and “containing” are to be construed as open-ended terms (i.e., meaning “including, but not limited to,”) unless otherwise noted. The terms “substantially,” “generally,” and other words of degree are relative modifiers intended to indicate permissible variation from the characteristic so modified. The use of such terms in describing a physical or functional characteristic of the invention is not intended to limit such characteristic to the absolute value that the term modifies, but rather to provide an approximation of the value of such physical or functional characteristic. All methods described herein can be performed in any suitable order unless otherwise specified herein or clearly indicated by context.

Terms concerning attachments, coupling and the like, such as “attached,” “connected,” and “interconnected,” refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as,” “preferred,” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity. Several terms are specifically defined herein. These terms are to be given their broadest reasonable construction consistent with such definitions, as follows:

As used herein, the term “actuator” means any device, mechanism, assembly or combination thereof that is adapted to move or be moved between a retracted position and an extended position so as to impart a mechanical force. The term “actuator” includes without limitation linear actuators, rotary actuators, hydraulic cylinders, hydraulic rotary actuators, pneumatic cylinders, springs and the like.

### SUMMARY OF THE INVENTION

The apparatus of the invention comprises a mobile safety tower having a base assembly that includes a base housing, an inverter that is disposed in the base housing, a power source that is disposed in the base housing, a communications router that is disposed in the base housing, a camera power supply unit that is disposed in the base housing, a controller that is disposed in the base housing, an internally-cabled tube that is adapted to be moved between a retracted position and an extended position, a means for moving the internally-cabled tube between the retracted position and the extended position, a camera that is disposed on the internally-cabled tube, a plurality of data collection sensors that are disposed on the internally-cabled tube and the base housing, and a solar energy source that is disposed on the internally-cabled tube. In the preferred mobile safety tower, the means for moving the internally-cabled tube between the retracted position and the extended position moves the internally-cabled tube between the retracted position and the extended position.

The method of the invention comprises a method for a mobile safety tower. The preferred method comprises providing a mobile safety tower. The preferred mobile safety tower comprises a base assembly that includes a base housing, an inverter that is disposed in the base housing, a power source that is disposed in the base housing, a communications router that is disposed in the base housing, a camera power supply unit that is disposed in the base housing, a controller that is disposed in the base housing, an internally-cabled tube that is adapted to be moved between a retracted position and an extended position, a means for moving the internally-cabled tube between the retracted position and the extended position, a camera that is disposed on the internally-cabled tube, a plurality of data collection sensors that are disposed on the internally-cabled tube and the base housing, and a solar energy source that is disposed on the internally-cabled tube. In the preferred mobile safety tower, the means for moving the internally-cabled tube between the retracted position and the extended position moves the internally-cabled tube between the retracted position and the extended position. The preferred method further comprises moving the internally-cabled tube between the retracted position and the extended position.

### BRIEF DESCRIPTION OF THE DRAWINGS

The presently preferred embodiments of the invention are illustrated in the accompanying drawings, in which like reference numerals represent like parts throughout, and in which:

FIG. 1 is a front view of the preferred embodiment of the mobile safety tower in accordance with the present invention with the tube shown in the retracted position.

FIG. 2 is a front view of the preferred mobile safety tower illustrated in FIG. 1 with the tube shown in the extended position.

FIG. 3 is a sectional front view of the preferred mobile safety tower illustrated in FIGS. 1-2.

FIG. 4 is a partial sectional top view of the preferred mobile safety tower illustrated in FIGS. 1-3.

FIG. 5 is a partial sectional side view of a first alternative embodiment of the preferred mobile safety tower shown mounted on an exemplary truck with the tube in the retracted position.

FIG. 6 is a side view of the preferred mobile safety tower illustrated in FIG. 5 with the tube in the extended position.

FIG. 7 is a top partial sectional view of the preferred mobile safety tower illustrated in FIGS. 5-6.

FIG. 8 is a bottom view of the preferred mobile safety tower illustrated in FIGS. 5-7.

FIG. 9 is a side view of the preferred mounting assembly of the mobile safety tower illustrated in FIGS. 5-8.

FIG. 10 is a schematic view of the preferred wiring assembly of the mobile safety tower illustrated in FIGS. 1-4.

FIG. 11 is a schematic view of the preferred wiring assembly of the mobile safety tower illustrated in FIGS. 5-9.

### DESCRIPTION OF THE PREFERRED EMBODIMENTS OF THE INVENTION

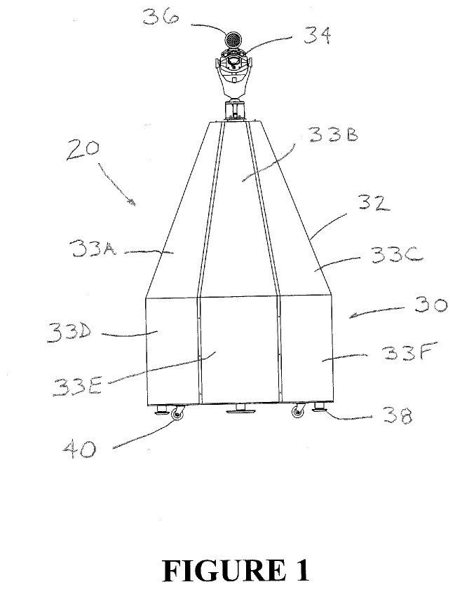

Referring now to the drawings, the preferred embodiments of the mobile safety tower in accordance with the present invention are illustrated by FIGS. 1 through 10. Referring now to FIG. 1, a front view of the preferred embodiment of the mobile safety tower in accordance with the present invention is illustrated with the tube shown in the retracted position. As shown in FIG. 1, the preferred mobile safety tower is designated generally by reference numeral 20. Preferred mobile safety tower 20 comprises base assembly 30 having base housing 32. Preferred base assembly 30 is weatherproof. Preferred base housing 32 base housing comprises a plurality of base housing segments 33A-F, at least one of which is removably attached to the base assembly. Preferred mobile safety tower also comprises camera 34 and speaker 36. Preferred camera 34 is adapted to convert images into electric signals and preferred 36 speaker is adapted to convert electromagnetic waves into acoustic waves in order to produce audible sound such as for a siren/public address system or buzzer. It is also contemplated within the scope of the invention that preferred mobile safety tower 20 may include an auxiliary flood lighting assembly. Preferred mobile safety tower further comprises interior leveling system 38 and wheels 40.

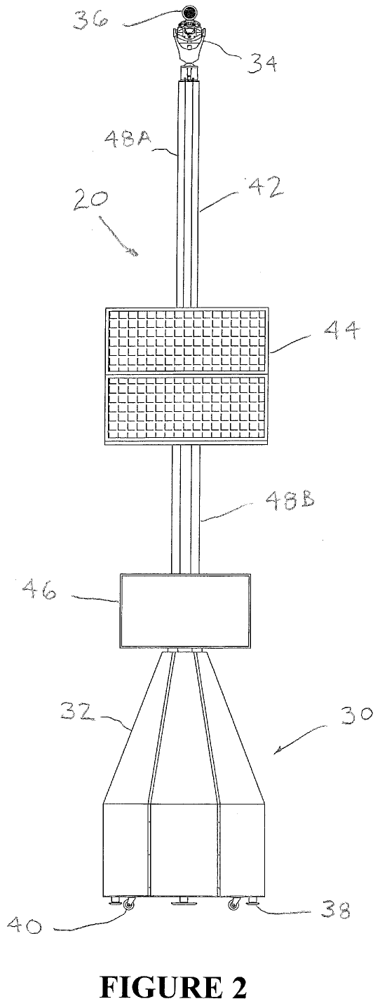

Referring now to FIG. 2, a front view of preferred mobile safety tower 20 is illustrated with the tube shown in the extended position. As shown in FIG. 2, preferred mobile safety tower comprises base assembly 30 having base housing 32. Preferred mobile safety tower also comprises camera 34 and speaker 36. Preferred camera 34 and preferred speaker 36 are disposed on internally-cabled tube 42. Preferred mobile safety tower further comprises interior leveling system 38 and wheels 40. Preferred mobile safety tower still further comprises a solar energy source such as solar panel 44 and a video display device such as television screen 46. Preferred internally-cabled tube 42 is adapted to be moved between a retracted position and an extended position and comprises telescoping tube segments 48A and 48B. It is contemplated within the scope of the invention that the preferred solar energy source may comprise a rigid solar panel, a flexible solar panel, and/or solar film. It is further contemplated within the scope of the invention that the preferred solar energy source may be disposed on the base assembly.

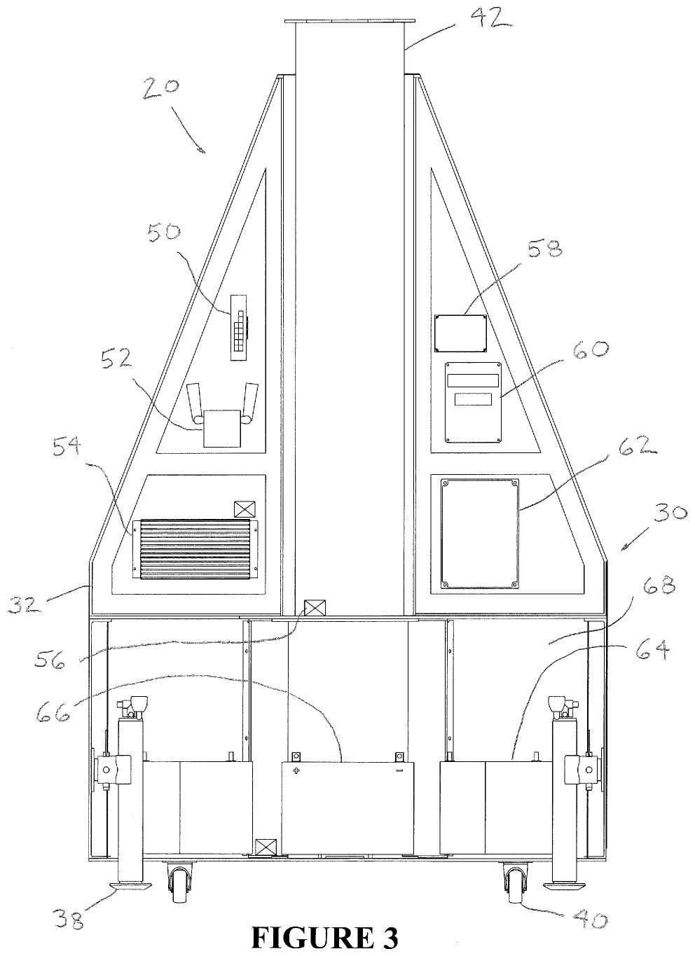

Referring now to FIG. 3, a sectional front view of preferred mobile safety tower 20 is illustrated. As shown in FIG. 3, preferred mobile safety tower comprises base assembly 30 having base housing 32. Preferred mobile safety tower also comprises interior leveling system 38 and wheels 40. Preferred mobile safety tower further comprises internally-cabled tube 42. Preferred mobile safety tower still further comprises router 50, modem 52, inverter 54, a plurality of data collection sensors 56, tamper alert system 58, controller 60, camera power supply 62, a power source such as battery 64, a means for moving the internally-cabled tube between a retracted position and an extended position such as compressor 66, and base storage compartment 68. Preferred router 50, preferred modem 52, preferred inverter 54, preferred tamper alert system 58, preferred solar controller 60, preferred camera power supply 62, preferred battery 64, and preferred compressor 66 are disposed in base housing 32. Preferred plurality of data collection sensors 56 are disposed on base housing 32 and internally-cabled tube 42.

Still referring to FIG. 3, the preferred means for moving the internally-cabled tube between the retracted position and the extended position moves the internally-cabled tube between the retracted position and the extended position The preferred means for moving the internally-cabled tube between the retracted position and the extended position may also comprise a motor, a generator, an actuator, or any other suitable device, mechanism, assembly, or combination thereof. Preferred compressor 66 comprises a valve block and solenoids that are wired to a remote switch. Preferably, the leads are wired to power through a custom switch panel mounted on the dashboard of the vehicle near the steering wheel with one lead wired to the panel in order to power the compressor solenoid for extension of the tube. The other lead preferably powers a solenoid adapted to open a relief valve on the valve block and retract the tube using gravitational force. The preferred switch panel can be programmed to turn on and off power to the mobile safety tower, the inverter, the solar controller, the modem, the router, the GPS, the tamper alert system, the camera power supply, the warning/emergency lights and buzzer, the data collection sensors, the siren/public address system, and the auxiliary flood lighting. While the preferred switch panel is mounted in a vehicle, it is contemplated within the scope of the invention that the switch panel may be disposed in other locations and used in connection with other preferred embodiments and applications of the invention. Preferred data collection sensors 56 comprise wireless transmitters and receivers that function as ubiquity point-to-point radio links. Preferred tamper alert system 58 comprises a GPS tracking device with a motion sensor.

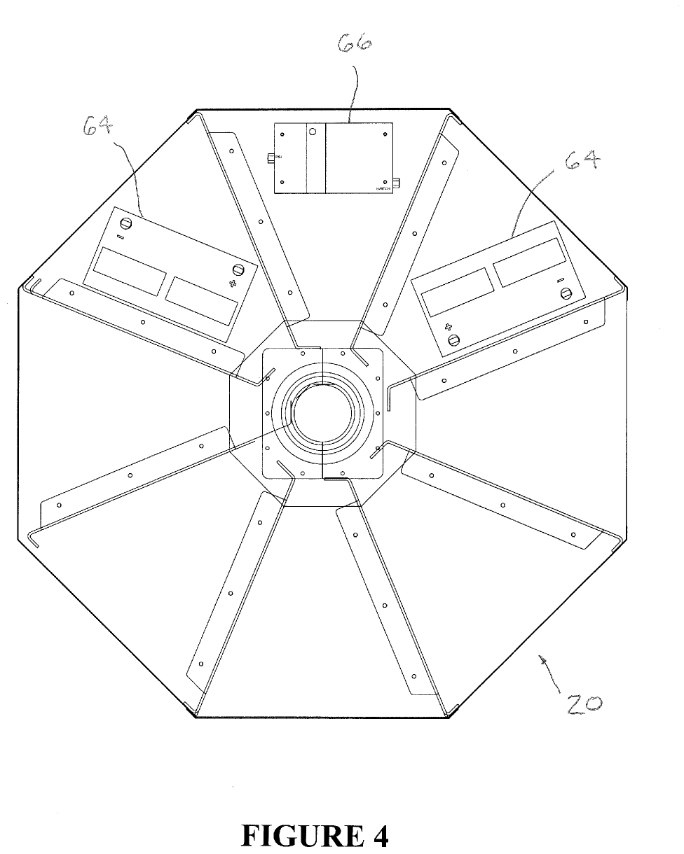

Referring now to FIG. 4, a partial sectional top view of preferred mobile safety tower 20 is illustrated. As shown in FIG. 4, preferred mobile safety tower comprises batteries 64 and compressor 66.

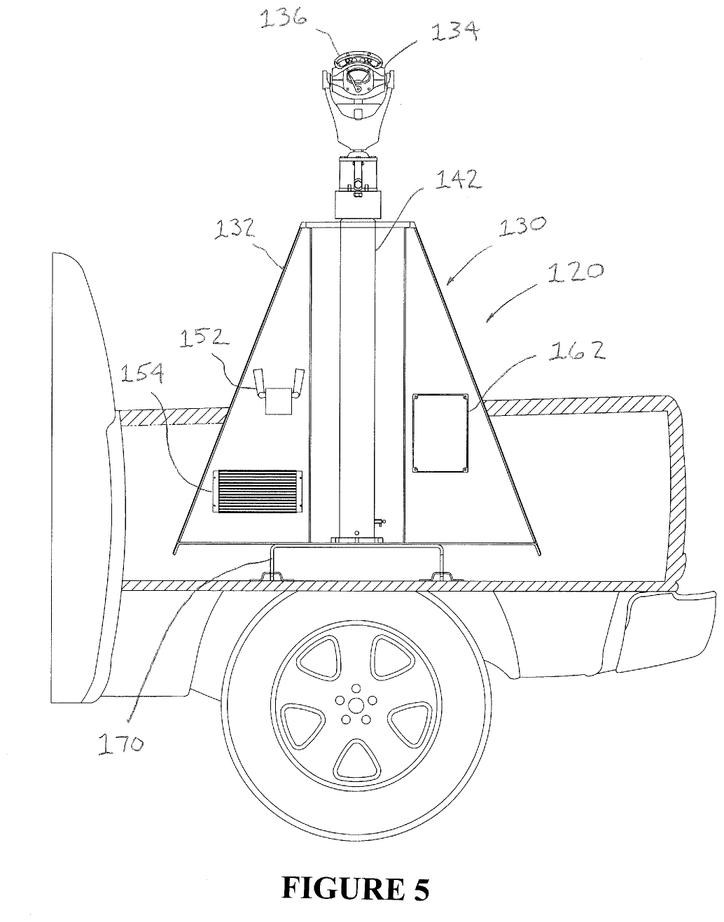

Referring now to FIG. 5, a partial sectional side view of a first alternative embodiment of the preferred mobile safety tower shown mounted on an exemplary truck with the tube in the retracted position. As shown in FIG. 5, the preferred first alternative embodiment is designated generally by reference numeral 120. Preferred mobile safety tower 120 comprises base assembly 130, base housing 132, camera 134, speaker 136, internally-cabled tube 142, modem 152, inverter 154, and camera power supply 162. Preferred mobile safety tower 120 further comprises mounting assembly 170. In preferred mobile safety tower 120, a safety mechanism such as a buzzer or flashing light is provided to indicate that the internally-cabled tube is in the extended position in order to reduce the risk of driving a vehicle while the tube is in the extended position.

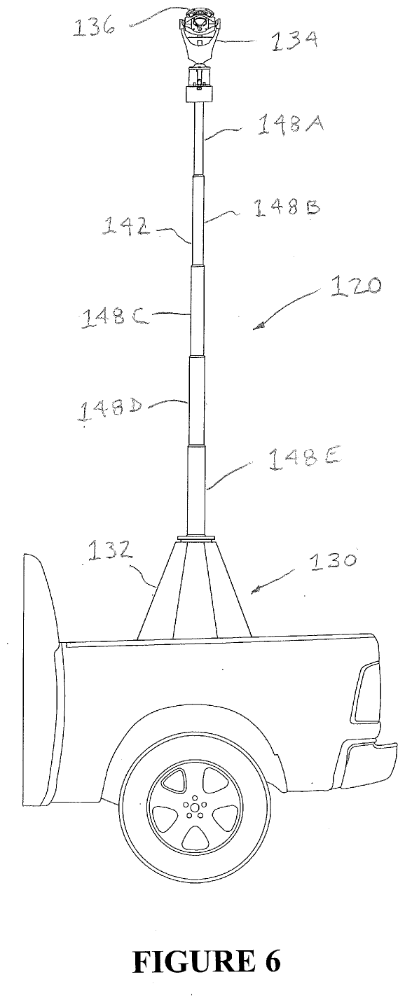

Referring now to FIG. 6, a side view of preferred mobile safety tower 120 is illustrated with the tube in the extended position. As shown in FIG. 6, preferred mobile safety tower 120 comprises base assembly 130, base housing 132, camera 134, speaker 136, internally-cabled tube 142, and telescoping tube segments 148A-E.

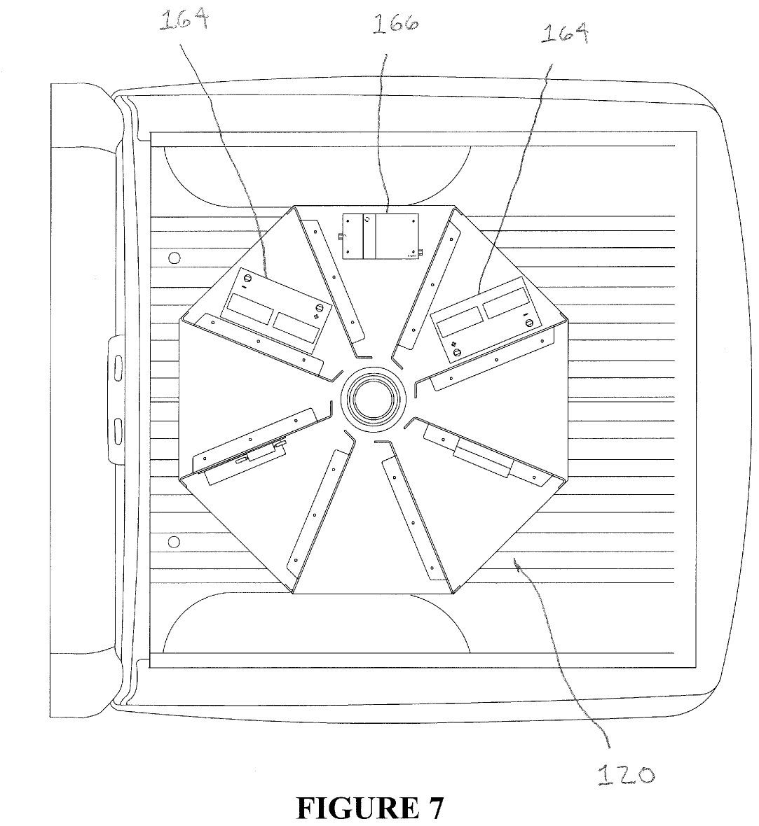

Referring now to FIG. 7, a top partial sectional view of preferred mobile safety tower 120 is illustrated. As shown in FIG. 7, preferred mobile safety tower 120 comprises batteries 164 and compressor 166.

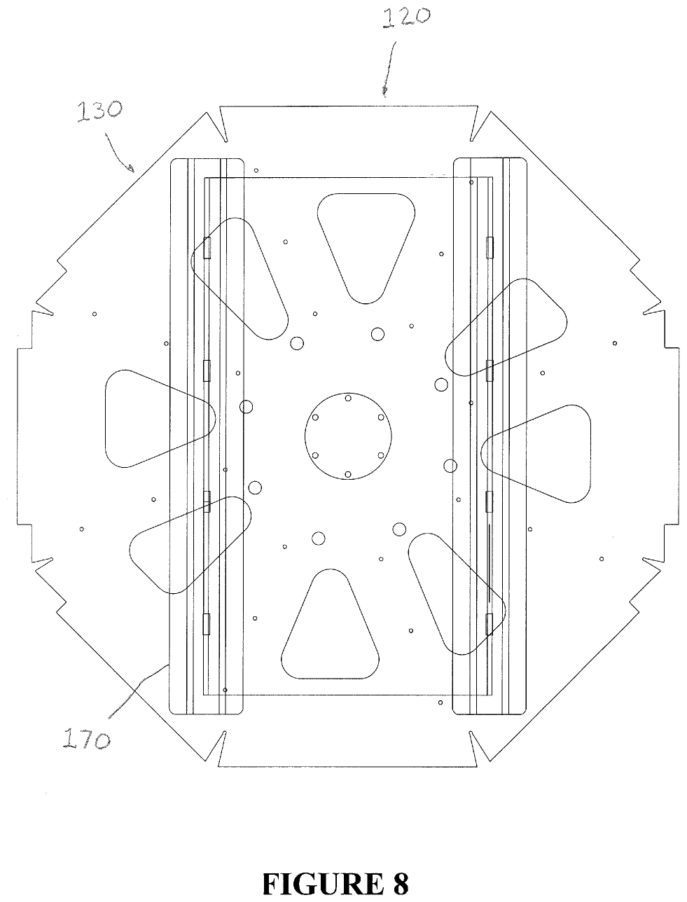

Referring now to FIG. 8, a bottom view of preferred mobile safety tower 120 is illustrated. As shown in FIG. 8, preferred mobile safety tower 120 comprises base assembly 130 and mounting assembly 170.

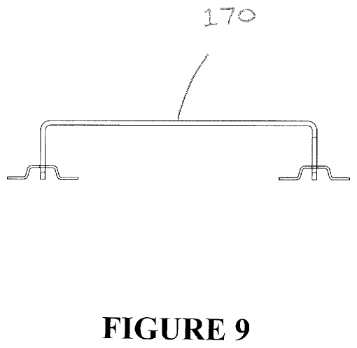

Referring now to FIG. 9, a side view of preferred mounting assembly 170 of mobile safety tower 120 is illustrated.

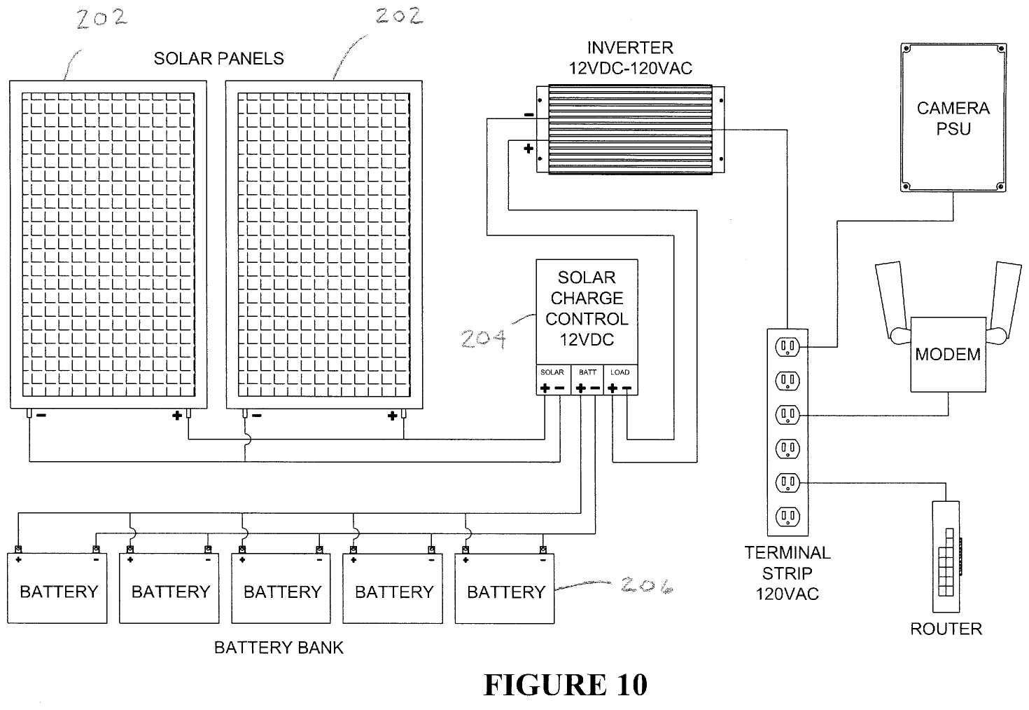

Referring now to FIG. 10, a schematic view of the preferred wiring system for preferred mobile safety tower 20 is illustrated. As shown in FIG. 10, the preferred wiring system for preferred mobile safety tower 20 is designated generally by reference numeral 200. In preferred wiring system 200, solar panels 202 and solar controller 204 charge battery bank 206, and the alternator system is non-existent.

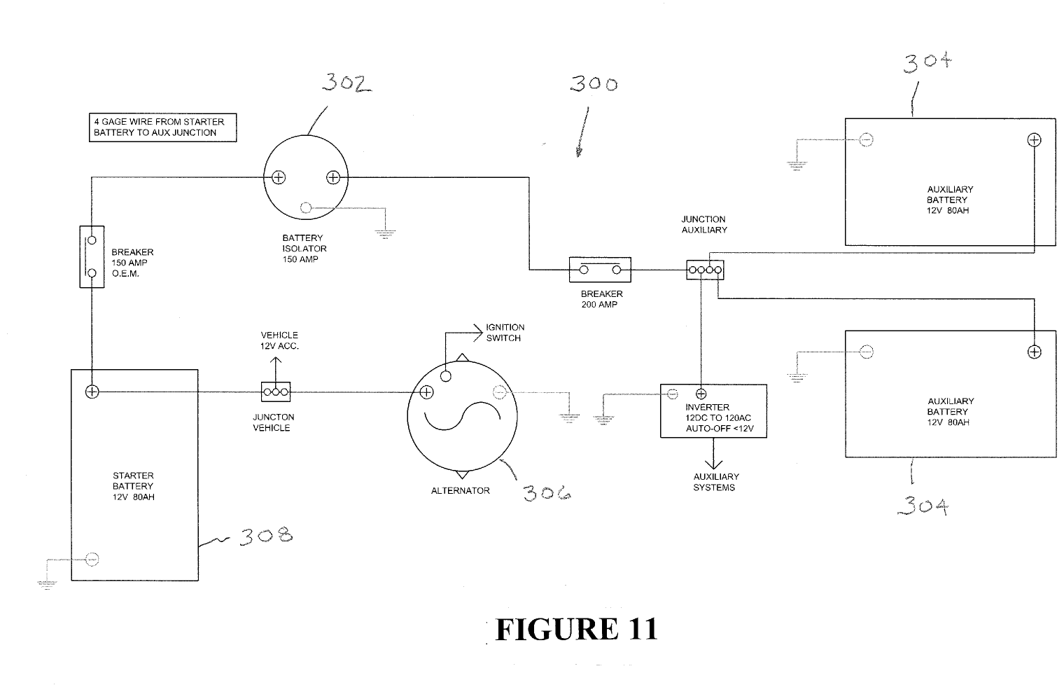

Referring now to FIG. 11, a schematic view of the preferred wiring system for preferred mobile safety tower 120 is illustrated. As shown in FIG. 11, the preferred wiring system for preferred mobile safety tower 120 is designated generally by reference numeral 300. Preferred wiring system 300 comprises battery-isolator 302 as a component in conjunction with separate (auxiliary) battery bank 304. Preferred battery isolator 302 provides one-way charging from vehicle alternator 306 to preferred battery bank 304 while preventing discharge of the vehicle starting battery 308. Preferably, the operator could draw preferred battery bank 304 down to a specific percentage and preferred mobile safety tower 120 would then power-down; and in the process, preferred starting battery 308 remains unaffected. Also in preferred wiring system 300, starting battery 308 may be used as a camera power source, and the wiring system is capable of rendering the vehicle inoperable if mobile safety tower 120 draws all the power down to zero.

The invention also comprises a method for a mobile safety tower. The preferred method comprises providing a mobile safety tower. The preferred mobile safety tower comprises a base assembly that includes a base housing, an inverter that is disposed in the base housing, a power source that is disposed in the base housing, a communications router that is disposed in the base housing, a camera power supply unit that is disposed in the base housing, a controller that is disposed in the base housing, an internally-cabled tube that is adapted to be moved between a retracted position and an extended position, a means for moving the internally-cabled tube between the retracted position and the extended position, a camera that is disposed on the internally-cabled tube, a plurality of data collection sensors that are disposed on the internally-cabled tube and the base housing, and a solar energy source that is disposed on the internally-cabled tube. In the preferred mobile safety tower, the means for moving the internally-cabled tube between the retracted position and the extended position moves the internally-cabled tube between the retracted position and the extended position. The preferred method further comprises moving the internally-cabled tube between the retracted position and the extended position.

In operation, several advantages of the preferred embodiments of the mobile safety tower are achieved. For example, the preferred embodiments of the invention claimed herein provide an apparatus and method for a mobile safety tower that is mobile, rapidly deployable, and autonomous. The preferred embodiments of the invention claimed herein also provide an apparatus and method for a mobile safety tower that employs advanced, seamless, off-the-grid technology and alternative, sustainable, renewable energy sources. The preferred embodiments of the invention claimed herein further provide an apparatus and method for a mobile safety tower that is modular, robust, stable, or customizable. The preferred embodiments of the invention claimed herein still further provide an apparatus and method for a mobile safety tower that is aesthetically subtle. In addition, the preferred embodiments of the invention claimed herein provide an apparatus and method for a mobile safety tower that does not have external cabling and wiring. The preferred embodiments of the invention claimed herein also provide an apparatus and method for a mobile safety tower that is not be capable of being moved, tipped over, or otherwise damaged by unauthorized persons or has an undesirably large footprint.

Further, the preferred embodiments of the invention claimed herein to provide an apparatus and method for a mobile safety tower that provides storage space for equipment or supplies. Still further, of the preferred embodiments of the invention claimed herein provide an apparatus and method for a mobile safety tower that provides sufficient safety and security. It is contemplated within the scope of the invention that in addition to truck and stand-alone applications, the preferred embodiments of the mobile safety tower may have trailer and marine applications.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. A mobile safety tower, said mobile safety tower comprising:
(a) a base assembly, said base assembly having a base housing;
(b) an inverter, said inverter being disposed in the base housing;
(c) a power source, said power source being disposed in the base housing;
(d) a communications router, said communications router being disposed in the base housing;
(e) a camera power supply unit, said camera power supply unit being disposed in the base housing;
(f) a controller, said controller being disposed in the base housing
(g) an internally-cabled tube, said internally-cabled tube being adapted to be moved between a retracted position and an extended position;
(h) a means for moving the internally-cabled tube between the retracted position and the extended position;
(i) a camera, said camera being disposed on the internally-cabled tube;
(j) a plurality of data collection sensors, said plurality of data collection sensors being disposed on the internally-cabled tube and the base housing;
(k) a solar energy source, said solar energy source being disposed on the internally-cabled tube;
wherein the means for moving the internally-cabled tube between the retracted position and the extended position moves the internally-cabled tube between the retracted position and the extended position.

2. The mobile safety tower of claim 1 wherein the means for moving the internally-cabled tube between the retracted position and the extended position comprises a compressor.

3. The mobile safety tower of claim 1 wherein the means for moving the internally-cabled tube between the retracted position and the extended position comprises a motor.

4. The mobile safety tower of claim 1 wherein the means for moving the internally-cabled tube between the retracted position and the extended position comprises a generator.

5. The mobile safety tower of claim 1 wherein the internally-cabled tube comprises telescoping tube segments.

6. The mobile safety tower of claim 1 further comprising a speaker.

7. The mobile safety tower of claim 1 further comprising a modem.

8. The mobile safety tower of claim 1 further comprising a video display device.

9. The mobile safety tower of claim 1 further comprising interior leveling system.

10. The mobile safety tower of claim 1 further comprising a tamper alert system.

11. The mobile safety tower of claim 1 further wherein the solar energy source is a solar panel.

12. The mobile safety tower of claim 1 further comprising a base storage compartment.

13. The mobile safety tower of claim 1 wherein the base housing comprises a plurality of base housing segments, at least one of said base housing segments being removably attached to the base assembly.

14. The mobile safety tower of claim 1 further comprising an internal cabling and wiring assembly.

15. The mobile safety tower of claim 1 further comprising a mounting assembly.

16. The mobile safety tower of claim 1 wherein the base assembly is weatherproof.

17. The mobile safety tower of claim 1 wherein the power source comprises a battery.

18. A method for a mobile safety tower, said method comprising:
(a) providing a mobile safety tower, said mobile safety tower comprising:
(i) a base assembly, said base assembly having a base housing;
(ii) an inverter, said inverter being disposed in the base housing;
(iii) a power source, said power source being disposed in the base housing;
(iv) a communications router, said communications router being disposed in the base housing;
(v) a camera power supply unit, said camera power supply unit being disposed in the base housing;
(vi) a controller, said controller being disposed in the base housing;
(vii) an internally-cabled tube, said internally-cabled tube being adapted to be moved between a retracted position and an extended position;
(viii) a means for moving the internally-cabled tube between the retracted position and the extended position;
(ix) a camera, said camera being disposed on the internally-cabled tube;
(x) a plurality of data collection sensors, said plurality of data collection sensors being disposed on the internally-cabled tube and the base housing;
(xi) a solar energy source, said solar energy source being disposed on the internally-cabled tube;
wherein the means for moving the internally-cabled tube between the retracted position and the extended position moves the internally-cabled tube between the retracted position and the extended position;
(b) moving the internally-cabled tube between the retracted position and the extended position.
